(19) United States
(12) Patent Application Publication
(10) Pub. No.: US 2008/0237553 A1
(43) Pub. Date: Oct. 2, 2008

(54) Colored photosensitive resin composition, and color filter array and solid-state image pickup device using the same

(75) Inventors: Yoshiko Miya, Kyoto-shi (JP); Kensaku Maeda, Tokyo (JP); Taichi Natori, Tokyo (JP)

Correspondence Address: WENDEROTH, LIND & PONACK, L.L.P., 2033 K STREET N. W., SUITE 800, WASHINGTON, DC, 20006-1021, US

(73) Assignees: SUMITOMO CHEMICAL COMPANY, LIMITED; SONY CORPORATION

(21) Appl. No.: 12/078,271

(22) Filed: Mar. 28, 2008

(30) Foreign Application Priority Data
Mar. 28, 2007 (JP) 2007-086043

(51) Int. Cl. C08F 2/50

(52) U.S. Cl. 252/586

(57) ABSTRACT

A colored photosensitive resin composition comprising an alkali-soluble resin, a photosensitive compound, a curing agent, a solvent and a colorant represented by the formula (I):

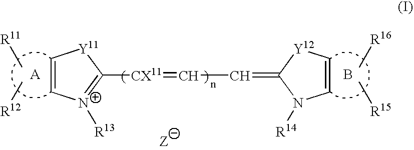

The colored photosensitive resin composition can form a color filter array which shows good spectral characteristics.

### BACKGROUND OF THE INVENTION

1. Field of the Invention

The present invention relates to a colored photosensitive resin composition which is useful to produce a color filter array to be formed on a device for coloration of a solid image pickup device (e.g., an image sensor, etc.) and a liquid crystal display.

2. Description of the Related Art

As a color filter array for coloring a solid image pickup device and a liquid crystal display, for example, there is known a color filter array in which a red filter layer (R), a green filter layer (G) and a blue filter layer (B) are formed adjacently to each other on the same plane of the device. As the filter layer, besides the combination of primary colors of red (R), green (G) and blue (B), a combination of complementary colors of yellow (Y), magenta (M) and cyan (C) may be employed.

The color filter array is usually produced by a color resist method in which colored photosensitive resin compositions corresponding to the respective filter layers are prepared and then patterned by successively exposing and developing the colored photosensitive resin compositions. Pigments are widely used as colorants contained in the colored photosensitive resin compositions. However, the pigments are not dissolved in a developing solution and they are therefore disadvantageous for forming fine patterns. Thus, the use of a dye is proposed as a colorant soluble in the developing solution.

For example, JP-A-2002-14222 discloses a triarylmethane colorant (dye) having an absorption maximum in a wavelength range of 550 to 650 nm as a dye having excellent spectral characteristics in the field of solid image pickup devices. JP-A-2002-14222 actually confirms in the Examples that C.I. Acid Blue 90, which is a colorant represented by the formula (IIa), has extremely excellent spectral characteristics.

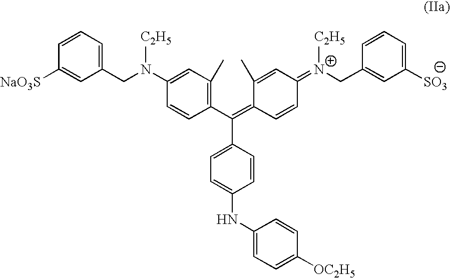

In each filter layer of a color filter array, a color is developed using a primary colorant alone, or a color may be developed using a primary colorant in combination with a secondary colorant (a colorant for color matching). JP-A-2002-14222 discloses that the spectral characteristics of a blue filter layer are controlled, that is, color matching is carried out, by using the blue triarylmethane colorant (dye) described above in combination with a xanthene red colorant having an absorption maximum in a wavelength range of 500 to 600 nm. The Examples of JP-A-2002-14222 show that a xanthene colorant represented by the formula (IIIa) has excellent effects on the improvement of the spectral characteristics of a blue filter layer.

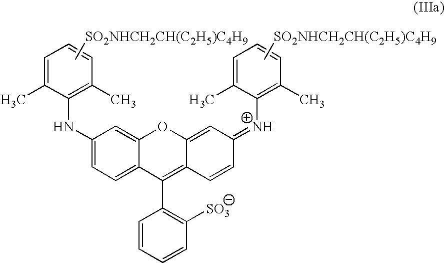

### SUMMARY OF THE INVENTION

In response to the recent trends of miniaturization of a pattern of a solid image pickup device, the miniaturization of the filter pattern becomes necessary. It is effective for miniaturization of the filter pattern to improve the spectral characteristics of a color filter array and thus decrease the thickness of the color filter array itself.

Thus, an object of the present invention is to provide a colored photosensitive resin composition capable of forming a color filter array which shows further good spectral characteristics. Herein, the “good spectral characteristics” means that light of in a specific wavelength range is sufficiently absorbed, while light in other wavelength range(s) is well transmitted.

The present inventors have intensively studied so as to achieve the above object and found that specific cyanine colorants having a common basic structure have excellent effects on the improvement of the spectral characteristics of a color filter array even when they are used as primary colorants or secondary colorants (colorants for color matching), and thus the present invention has been completed.

Accordingly, the present invention provides a colored photosensitive resin composition comprising an alkali-soluble resin, a photosensitive compound, a curing agent, a solvent and a cyanine colorant represented by the formula (I):

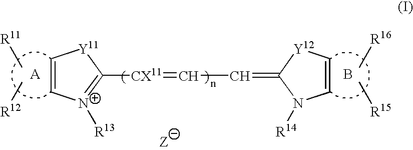

wherein

Z⁻ represents Cl⁻, Br⁻, I⁻, ClO₄⁻, OH⁻, a carboxylate anion, a sulfonate anion, or a borate anion;

Y¹¹ and Y¹² each independently represents a sulfur atom, an oxygen atom, a selenium atom, an ethylene group, or a dimethylmethylene group;

X¹¹ represents a hydrogen atom or a halogen atom;

R¹¹, R¹², R¹⁵ and R¹⁶ each independently represents a hydrogen atom, a chlorine atom, a C₁₋₄ alkyl group, a C₁₋₄ haloalkyl group, an ethylenyl group, a styryl group, a C₁₋₄ alkoxyl group, a phenyl group, a naphthyl group, a phenyl group substituted with a C₁₋₄ alkyl group, a hydroxyphenyl group, a halophenyl group, a nitrophenyl group, an aminophenyl group, a nitro group, an amino group, or a hydroxyl group;

R¹³ and R¹⁴ each independently represents a C₁₋₈ alkyl group, a C₁₋₈ alkoxyl group, or a C₁₋₈ hydroxyalkyl group;

n represents an integer from 1 to 5; and

rings A and B represented by a dotted line each independently represents a benzene ring or a naphthalene ring.

Herein, “C_{a-b}” means that the number of carbon atoms is from “a” to “b”.

The present invention further provides a color filter array formed using the colored photosensitive resin composition of the present invention, a solid image pickup device comprising such a color filter array, and a camera system comprising such a solid image pickup device.

According to the present invention, the spectral characteristics of a color filter array formed using the colored photosensitive resin composition of the present invention can be much improved since the cyanine colorant (I) is used.

### BRIEF DESCRIPTION OF DRAWINGS

FIG. 1 shows a partially enlarged view of one embodiment of a CCD image sensor on which a color filter array of the present invention is formed.

FIG. 2 shows a photosensitive resin composition colored with a first color applied on a flattened film.

FIG. 3 shows a photosensitive resin composition colored with a first color applied on a flattened film with projection exposure of a pattern through a photomask.

FIG. 4 shows insolubilized photosensitive resin composition in exposed area, thermocured to form a desired pattern.

FIG. 5 shows the formation of pixel patterns of additional colors on the plane of the substrate on which the image sensor is formed.

FIG. 6 shows a flattened film formed on the surface of the color filter array.

FIG. 7 shows a microlens for collecting light incident to a photodiode formed on the top surface of the flattened film.

FIG. 8 shows a block diagram showing an example of a camera system into which a solid image pickup device is assembled.

### DETAILED DESCRIPTION OF THE INVENTION

The colored photosensitive resin composition of the present invention is characterized in that it comprises the cyanine colorant represented by the formula (I). This cyanine colorant (I) can be classified into two types, namely, a colorant having a short conjugate system (hereinafter referred to as a “short conjugated cyanine colorant”) and a colorant having a long conjugate system (hereinafter referred to as a “long conjugated cyanine colorant”). The former, the short conjugated cyanine colorant, is preferably used as a secondary colorant, while the latter, the long conjugated cyanine colorant, is preferably used as a primary colorant. In particular, the short conjugated cyanine colorant means a colorant of the formula (I) in which both rings A and B represented by a dotted line are benzene rings and n is 1, and mainly develops a red color. When the blue colorant is used as a secondary colorant for color matching, the spectral characteristics of the color filter array can be improved. The long conjugated cyanine colorant means a colorant having a conjugate system which is longer than that of the above short conjugated cyanine colorant, and also satisfies at least one of the following conditions: (i) at least one of rings A and B is a naphthalene ring(s) and (ii) n is at least 2. The long conjugated cyanine colorant mainly develops a blue color and, when it is used as a primary colorant of a blue filter layer, the spectral characteristics of the blue filter layer can be improved.

Firstly, the long conjugated cyanine colorant among the cyanine colorants (I) will be hereinafter described in more detail.

As described above, the long conjugated cyanine colorant includes a colorant, which satisfies at least one of the c conditions: (i) at least one of rings A and B is a naphthalene ring(s) and (ii) n is at least 2, among the colorants represented by the formula (I). The long conjugated cyanine colorants may be used alone, or two or more of them may be used in combination.

In the long conjugated cyanine colorant, Z⁻ is preferably I⁻, ClO₄⁻, a benzenesulfonate anion, a 4-methylbenzenesulfonate anion, a 4-aminobenzenesulfonate anion or BF₄⁻, more preferably ClO₄⁻ or BF₄⁻. Preferably, Y¹¹ and Y¹² each independently represents a sulfur atom, an oxygen atom or a dimethylmethylene group, more preferably a dimethylmethylene group. X¹¹ is preferably a hydrogen atom or a bromine atom, more preferably a hydrogen atom. Preferably, R¹¹, R¹², R¹⁵ and R¹⁶ each independently represents a hydrogen atom, a chlorine atom or a C₁₋₄ alkyl group, more preferably a hydrogen atom. Preferably, R¹³ and R¹⁴ each independently represents a C₁₋₄ alkyl group, more preferably an n-propyl group or an n-butyl group. n is preferably an integer from 1 to 3, more preferably 1 or 2. Both rings A and B represented by a dotted line may be benzene rings when n is 2 or more. When n is 1, at least one of the rings A and B is a naphthalene ring. When n is 1 or more, both rings A and B are preferably naphthalene rings. More specifically, among the cyanine colorants (I), the compounds represented by the following formulae (I-1) to (I-5) or salts thereof are preferred as the long conjugated cyanine colorants.

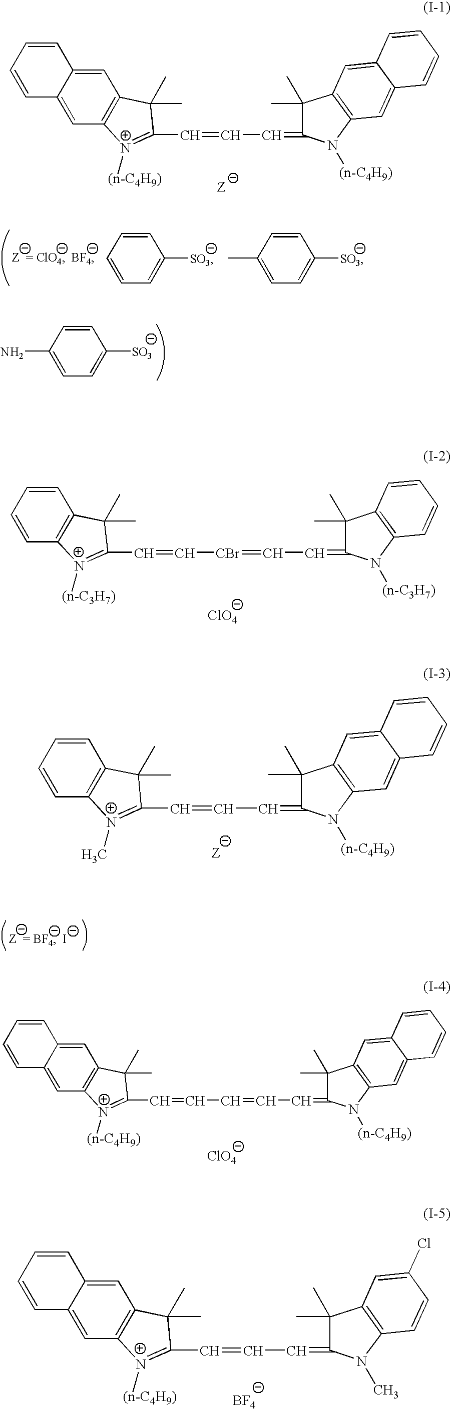

The long conjugated cyanine colorant has the excellent spectral characteristics and can be used alone as the primary colorant of the blue filter layer, and the blue filter layer may further contain a colorant (dye) having an absorption maximum in a wavelength range of 500 to 600 nm so as to control the spectral characteristics. The colorant having the absorption maximum in a wavelength range of 500 to 600 nm includes, for example, a xanthene colorant represented by the formula (III) (hereinafter referred sometimes to as a “xanthene colorant (III)”):

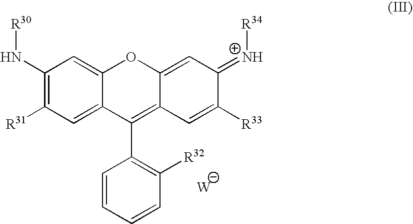

wherein

W⁻ represents BF₄⁻, PF₆⁻, X³⁰⁻ or X³¹O₄⁻ in which X³⁰ and X³¹ each independently represents a halogen atom;

R³¹ and R³³ each independently represents a hydrogen atom or a C₁₋₈ alkyl group;

R³² represents a sulfonic acid group, a carboxylic acid group, an ester or a salt thereof, or a sulfonamide group represented by the formula (III-1):

R³⁵HN—SO₂— (III-1)

in which R³⁵ represents a hydrogen atom, a C₂₋₂₀ alkyl group, a C₂₋₁₂ alkyl group substituted with a cyclohexyl group, a cyclohexyl group substituted with a C₁₋₄ alkyl group, a C₂₋₁₂ alkyl group substituted with a C₂₋₁₂ alkoxyl group, a phenyl group which may be substituted with a C₁₋₂₀ alkyl group, a C₁₋₂₀ alkyl group which may be substituted with a phenyl group, an alkylcarbonyloxyalkyl group represented by the formula (III-2), or an alkoxycarbonyl alkyl group represented by formula (III-3):

R³⁶—CO—O—R³⁷— (III-2)

R³⁸—O—CO—R³⁹— (III-3)

in which R³⁶ and R³⁸ each independently represents a C₂₋₁₂ alkyl group, and R³⁷ and R³⁹ each independently represents a C₂₋₁₂ alkylene group; and

R³⁰ and R³⁴ each independently represents a hydrogen atom, a C₁₋₈ alkyl group, or a substituted phenyl group represented by the formula (III-4):

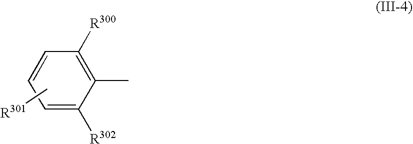

in which R³⁰⁰ and R³⁰² each independently represents a hydrogen atom or a C₁₋₃ alkyl group, R³⁰¹ represents a sulfonic acid group, a carboxylic acid group, an ester or a salt thereof, or a sulfonamide group represented by the formula (III-1).

Examples of the xanthene colorant (III) include C.I. Basic Red 1, C.I. Acid Red 289, or a colorant represented by the formula (IIIa).

The xanthene colorants (III) may be used alone, or two or more of them may be used in combination. The content of the xanthene colorant is preferably from about 1 to 70% by mass, more preferably from about 10 to 30% by mass, based on the total content of the cyanine colorant (I) and the xanthene colorant (III).

The colored photosensitive resin composition of the present invention may contain a colorant (dye) having an absorption maximum in a wavelength range of 600 to 700 nm as a colorant for color matching so as to improve the spectral characteristics of the colored photosensitive resin composition. Examples of the colorant having an absorption maximum in a wavelength range of 600 to 700 nm includes a copper phthalocyanine colorant (hereinafter referred sometimes to as a “copper phthalocyanine colorant (IV)”) represented by the formula (IV):

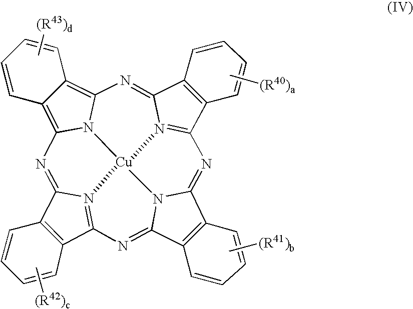

wherein
R⁴⁰ to R⁴³ each independently represents a sulfonic acid group, or a sulfonamide group represented by the formula (IV-1):

R⁴⁴HN—SO₂— (IV-1)

in which R⁴⁴ represents a hydrogen atom, C₂₋₂₀ alkyl group, a C₂₋₁₂ alkyl group substituted with cyclohexyl, a cyclohexyl group substituted with a C₁₋₄ alkyl group, a C₂₋₁₂ alkyl group substituted with a C₂₋₁₂ alkoxyl group, a phenyl group substituted with a C₁₋₂₀ alkyl group, a C₁₋₂₀ alkyl group substituted with a phenyl group, an alkylcarbonyloxyalkyl group represented by the formula (IV-2), or an alkoxycarbonyl alkyl group represented by the formula (IV-3):

R⁴⁵—CO—O—R⁴⁶— (IV-2)

R⁴⁷—O—CO—R⁴⁸— (IV-3)

in which R⁴⁵ and R⁴⁷ each independently represents a C₂₋₁₂ alkyl group, and R⁴⁶ and R⁴⁸ each independently represents a C₂₋₁₂ alkylene group; and

a, b, c and d each independently represents an integer from 0 to 2.

The copper phthalocyanine colorant (IV) can form a sulfonic acid salt when any one of R⁴⁰ to R⁴³ is a sulfonic acid group. Examples of the salts include metal salts with alkali metals such as sodium and potassium; and amine salts with amines such as trimethylamine, 2-ethylhexylamine, and 1-amino-3-phenylbutane.

Specific examples of the copper phthalocyanine colorant (IV) include C.I. Solvent Blue 25, C.I. Solvent Blue 55, C.I. Solvent Blue 67, C.I. Acid Blue 249, and C.I. Direct Blue 86. These copper phthalocyanine colorants (IV) may be used alone, or two or more of them may be used in combination. The copper phthalocyanine colorant (IV) and the xanthene colorant (III) may be used in combination as the colorants for color matching. The content of the copper phthalocyanine colorant (IV) is preferably from about 10 to 70% by mass, more preferably from about 20 to 50% by mass, based on the total content of the cyanine colorant (I) and the copper phthalocyanine colorant (IV).

Among the colorants represented by the formula (I), a short conjugated cyanine colorant is a colorant in which both rings A and B represented by a dotted line are benzene rings and n is 1. The short conjugated cyanine colorants may be used alone, or two or more of them may be used in combination. In the short conjugated cyanine colorant, preferred R¹¹ to R¹⁶, X¹¹, Y¹¹ and Y¹², and Z⁻ are the same as those in the case of the long conjugated cyanine colorant. Particularly preferred short conjugated cyanine colorants are those represented by the formulae (I-6) and (I-7).

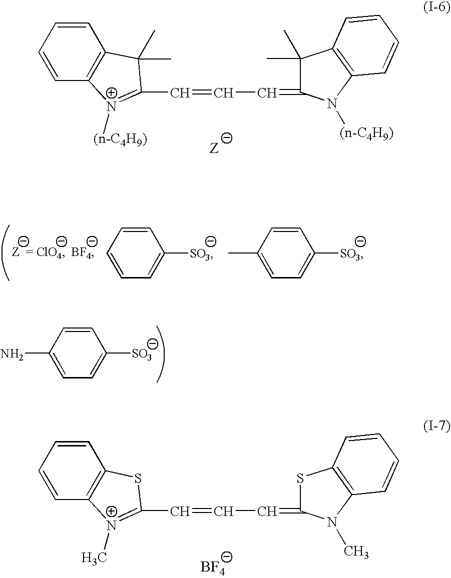

As described above, the short conjugated cyanine colorant is used as a secondary colorant for color matching of the blue primary colorant. The primary colorant subjected to color matching using the short conjugated cyanine colorant is not specifically limited, and various blue colorants may be used. The primary colorant is preferably the above long conjugated cyanine colorant and a colorant having an absorption maximum in a wavelength range of 550 to 650 nm, particularly a triarylmethane colorant represented by the formula (II) (hereinafter referred sometimes to as a “triarylmethane colorant (II)”):

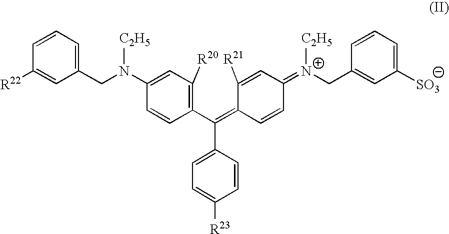

wherein

R²⁰ and R²¹ each independently represents a hydrogen atom or a C₁₋₃ alkyl group;

R²² represents a hydrogen atom or a sulfonic acid group; and

R²³ represents a hydrogen atom, a sulfonic acid group, a carboxylic acid group, a C₁₋₃ alkyl group, a C₁₋₃ alkoxyl group, or an amino group represented by the formula (II-1):

—NR²⁴R²⁵ (II-1)

in which R²⁴ and R²⁵ each independently represents a hydrogen atom, a C₁₋₃ alkyl group, a phenyl group, or a phenyl group in which a C₁₋₃ alkoxyl group is substituted at the p-position thereof.

The triarylmethane colorant (II) may be in the form of either a free compound or a sulfonic acid salt. Examples of the sulfonic acid salt include metal salts with alkali metals such as sodium and potassium; and amine salts with amines such as triethylamine, 2-ethylhexylamine, and 1-amino-3-phenylbutane.

Specific examples of the triarylmethane colorant (II) include C.I. Acid Blue 7, C.I. Acid Blue 83, C.I. Acid Blue 90, C.I. Solvent Blue 38, C.I. Acid Violet 17, C.I. Acid Violet 49, and C.I. Acid Green 3. The triarylmethane colorants (II) may be used alone, or two or more of them may be used in combination.

The content of the short conjugated cyanine colorant used as the colorant for color matching is preferably from about 1 to 70% by mass, more preferably from about 5 to 50% by mass, based on the total content of the primary colorant and the short conjugated cyanine colorant. The short conjugated cyanine colorant may be used in combination with other colorant for color matching such as the above copper phthalocyanine colorant (IV). The content of the copper phthalocyanine colorant (IV) as the colorant for color matching is preferably from about 30 to 70% by mass, more preferably from about 40 to 60% by mass, based on the total content of the primary colorant and the copper phthalocyanine colorant (IV).

In the field of colorant chemistry, a method for producing a cyanine colorant is well known, and the cyanine colorant (I) of the present invention may be produced by a known method. Those skilled in the art can produce various cyanine colorants (I) by appropriately modifying a method for producing a colorant (I-6a) or colorant (I-7) described hereinafter.

A method for producing colorant (I-6a) will be described as a typical example of the method for producing a cyanine colorant (I).

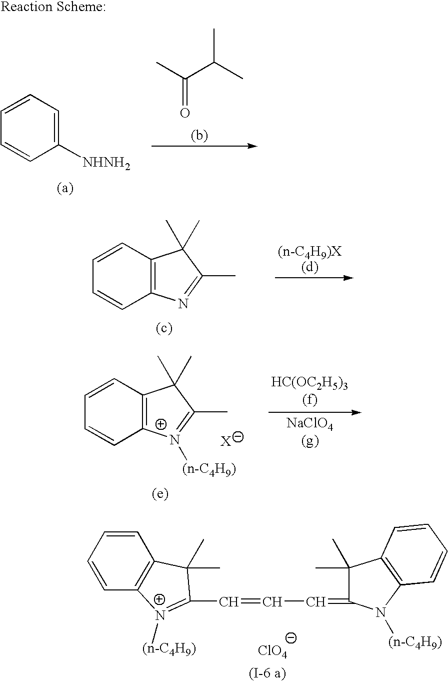

Firstly, benzenehydrazide (a) and isopropylketone (b) are heated in an acidic solvent (for example, acetic acid) and reacted while heating (for example, about 70 to 130° C.) for several hours (for example, 1 to 5 hours) to form 2,3,3-trimethylindole (c). Then, 2,3,3-trimethylindole (c) thus obtained and a halogenated butane (d) (in the above formula, X represents a halogen) in an organic solvent (for example, orthodichlorobenzene) and reacted while heating (for example, about 80 to 130° C.) for several hours (for example, 2 to 12 hours) to form an intermediate (e). The intermediate (e) thus obtained and ethyl orthoformate (f) are mixed in a basic solvent (for example, pyridine) and reacted while heating (for example, about 80 to 120° C.) for several hours (for example, 1 to 3 hours), followed by anion exchange with sodium perchlorate (g). Thus, a colorant (I-6a) can be produced.

A method for producing colorant (I-7) will now be described as a further typical example of the method for producing a cyanine colorant (I).

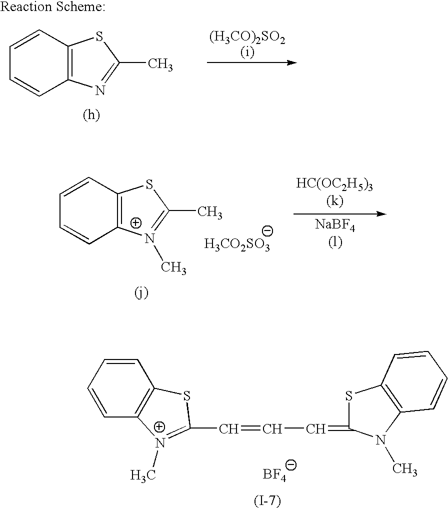

Firstly, 2-methylbenzothiazole (h) and methyl sulfate (i) are mixed in an organic solvent (for example, ethyl acetate) and reacted while heating (for example, under reflux) to form an intermediate (j). The intermediate (j) thus obtained and ethyl orthoformate (k) are reacted in a basic solvent (for example, pyridine, or a mixed solvent pyridine/DMF), followed by anion exhange with sodium fluoroborate (l). Thus, a colorant (I-7) can be produced.

Besided the cyanine colorant (I), the colored photosensitive resin composition of the present invention contains an alkali-soluble resin, a photosensitive compound, a curing agent and a solvent. The composition of the present invention is preferably a negative composition, although it may be a positive composition.

The photosensitive compound is appropriately selected according to the positive composition or the negative composition. The photosensitive compound for the positive composition is generally referred to as a photosensitizer and various known photosensitizers may be used. Specific examples of the photosensitizer include an ester of a phenol compound and an o-naphthoquinonediazidesulfonic acid compound (e.g., o-naphthoquinonediazide-5-sulfonic acid, o-naphthoquinonediazide-4-sulfonic acid, etc.).

Examples of the phenol compound include a di-, tri-, tetra- or pentahydroxybenzophenone (e.g., 2,3,4,40-tetrahydroxybenzophenone, etc.), and compounds represented by the formulae (101) to (111):

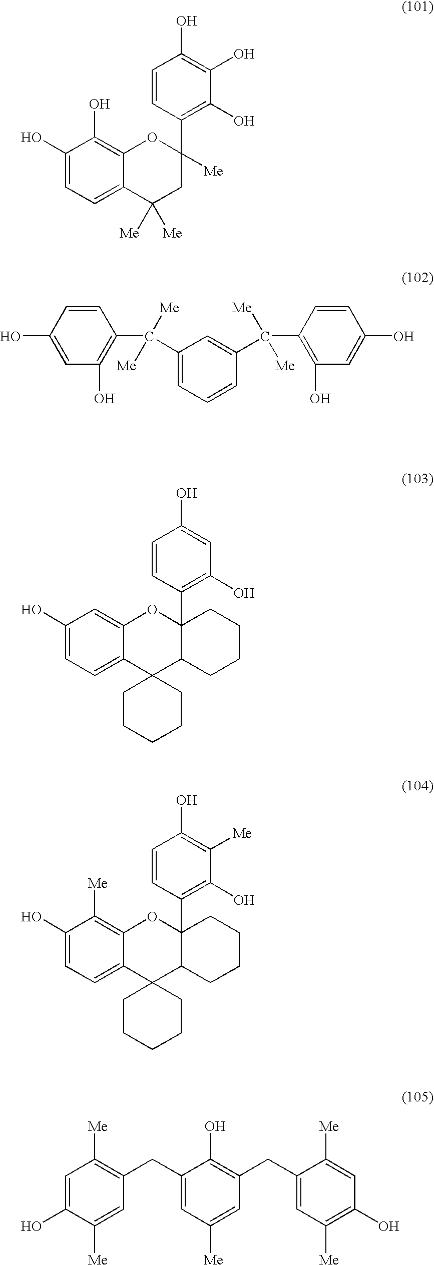

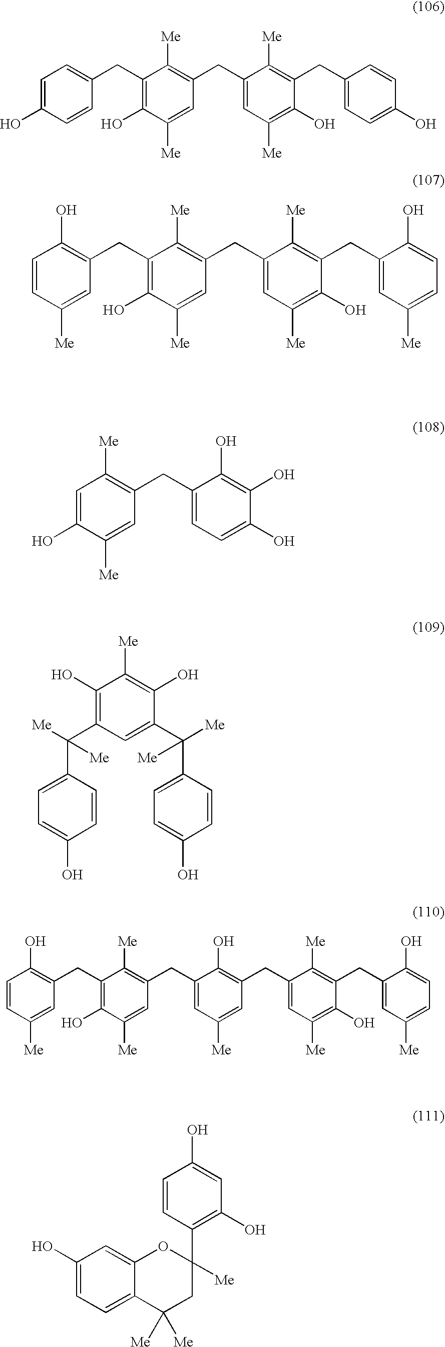

A photo acid generator can be used as the photosensitive compound for the negative composition. The kind of the photo acid generator is not specifically limited and various known photo acid generators may be used. Examples of the photo acid generator include an iodonium salt compound, a sulfonium salt compound, an organic halogen compound (haloalkyl-s-triazine compound, etc.), a sulfonate ester compound, a disulfone compound, a diazomethanesulfonyl compound, an N-sulfonyl oxyimide compound, an oxime compound, etc.). The photo acid generator is preferably an oxime compound.

Specific examples of the oxime compound include cyanides such as α-(4-toluenesulfonyloxyimino)benzyl cyanide, α-(4-toluenesulfonyloxyimino)-4-methoxybenzyl cyanide, α-(camphorsulfonyloxyimino)-4-methoxybenzyl cyanide, α-trifluoromethanesulfonyloxyimino-4-methoxybenzyl cyanide, α-(1-hexanesulfonyloxyimino-4-methoxybenzyl cyanide, α-naphthalenesulfonyloxyimino-4-methoxybenzyl cyanide, α-(4-toluenesulfonyloxyimino)-4-N-diethylanilyl cyanide, α-(4-toluenesulfonyloxyimino)-3,4-dimethoxybenzyl cyanide and α-(4-toluenesulfonyloxyimino)-4-thienyl cyanide; and acetonitriles such as α-[(4-toluenesulfonyloxyimino)-4-methoxyphenyl]acetonitrile, (5-tosyloxyimino-5H-thiophen-2-ylidene)-(2-methylphenyl)acetonitrile, (5-camphorsulfonyloxyimino-5H-thiophen-2-ylidene)-(2-methylphenyl)acetonitrile, (5-n-propyloxyimino-5H-thiophen-2-ylidene)-(2-methylphenyl)acetonitrile and (5-n-octyloxyimino-5-camphorsulfonyloxyimino-5H-thiophen-2-ylidene)-(2-methylphenyl)acetonitrile.

As the alkali-soluble resin, various known alkali-soluble resins used in a photoresist material may be used. Among them, resins having a phenolic hydroxyl group are preferably used. Specific examples of the novolak resin include a p-cresol novolak resin, an m-cresol novolak resin, a novolak resin of p-cresol and m-cresol and a novolak resin having a repeating structure represented by the formula (201):

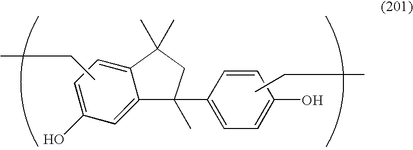

Examples of the polyvinyl resin include a polymer of vinylphenol (p-vinylphenol, also referred to as p-hydroxystyrene, etc.). This polymer may be a homopolymer, or a copolymer (e.g., a copolymer of styrene and p-vinylphenol). If necessary, a hydrogen atom of a hydroxyl group of vinylphenol may be substituted (masked) with an organic group (e.g., a C₁₋₆ alkyl group). When the hydroxyl group is masked with the organic group, the amount of exposing light in the formation of a pattern by a photolithography method can be decreased, and also it become easy to make a pattern shape to be a rectangular shape, which is preferred for a color filter.

The polystyrene-converted weight average molecular weight of the novolak resin is usually from about 3,000 to 20,000, and the polystyrene-converted weight average molecular weight of the polyvinyl resin is usually from about 1,000 to 20,000, preferably from about 2,000 to 6,000.

As the curing agent contained in the colored photosensitive resin composition of the present invention may be a compound having a thermocuring action and it is possible to use, for example, a melamine compound represented by the formula (301):

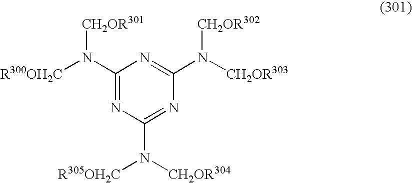

wherein R³⁰⁰ to R³⁰⁵ represent each independently a hydrogen atom, a linear C₁₋₁₀ alkyl group, preferably a linear C₁₋₄ alkyl group, or a C₃₋₁₀ branched chain alkyl group, preferably an isopropyl group, an isobutyl group, a sec-butyl group, a tert-butyl group, etc., provided that at least two substituents among R³⁰⁰ to R³⁰⁵ are not hydrogen atoms.

Preferable examples of the melamine compounds include hexamethoxymethylmelamine (also referred to as hexamethoxymethylolmelamine) and hexaethoxymethylmelamine.

In the colored photosensitive resin composition of the present invention, the contents of the colorant, the photosensitive compound, the alkali-soluble resin and the curing agent, based on 100 parts by weight of the total amount of the colorant, the photosensitive compound, the alkali-soluble resin and the curing agent (solid content), are as follows:

Colorant: The amount of the colorant is usually in a range from about 5 to 80 parts by weight, preferably from about 15 to 80 parts by weight, more preferably from about 20 to 70 parts by weight, and particularly from about 30 to 70 parts by weight. With such an amount of the colorant, the color density of the color filter can be sufficiently increased, and also the thickness loss in the developing step upon formation of a pattern can be decreased.

Photosensitive Compound: The amount of the photosensitive compound is usually in a range from about 0.001 to 50 parts by weight, preferably from about 0.01 to 40 parts by weight, more preferably from about 0.1 to 30 parts by weight, and particularly from about 0.1 to 10 parts by weight. With such an amount of the photosensitive compound, the thickness loss in the developing step upon formation of a pattern can be decreased, and also the exposure time in the formation of a pattern by a photolithography method can be shortened.

Alkali-Soluble Resin: The amount of the alkali-soluble resin is in a range from about 1 to 75 parts by weight, preferably from about 5 to 60 parts by weight, more preferably from about 10 to 50 parts by weight. With such an amount of the alkali-soluble resin, preferably the sufficient solubility in a developing solution is achieved, and also the thickness loss is less likely to occur in the developing step and light exposure upon formation of a pattern using a photolithography method decreases.

Curing agent: The content of the curing agent is preferably from 10 to 40% by weight, more preferably from 15 to 30% by weight, based on the solid content of the colored photosensitive resin composition. When the content of the curing agent is preferably within the above range, the amount of exposing light in the case of forming a pattern by a photolithography method can decrease, and a good pattern shape after the development and the sufficient mechanical strength of the pattern after curing the pattern with heating are attained, and also the thickness loss of a pixel pattern does not occur in the developing step and thus the color unevenness of the image is less likely to occur.

A solvent may be adequately selected depending on the solubility of the colorant (dye), the photosensitive compound, the alkali-soluble resin, the curing agent and other components contained in the colored photosensitive resin composition, in particular, the solubility of the colorant. Examples of the solvent include ethylene glycols (e.g., methyl cellosolve, ethyl cellosolve, methyl cellosolve acetate, ethyl cellosolve acetate, diethylene glycol dimethyl ether, ethylene glycol monoisopropyl ether, etc.), propylene glycols (e.g., propylene glycol monomethyl ether, propylene glycol monomethyl ether acetate, etc.), N-methylpyrrolidone, γ-butyrolactone, dimethyl sulfoxide, N,N-dimethylformamide, ketones (e.g., 4-hydroxy-4-methyl-2-pentanone, cyclohexanone, etc.), carboxylates (e.g., ethyl acetate, n-butyl acetate, ethyl pyruvate, ethyl lactate, butyl lactate, etc.). These solvents may be used alone or in combination.

The content of the solvent is preferably from 65 to 95% by weight, more preferably from 70 to 90% by weight, based on the colored photosensitive resin composition, because within the above range, the uniformity of the coating film can be improved.

The colored photosensitive resin composition of the present invention may optionally contain other components such as a surfactant. Examples of the surfactant include silicone-based surfactant, fluorine-based surfactant, and silicone-based surfactant having a fluorine atom. The silicone-based surfactant includes, for example, a surfactant having a siloxane bond. Specific examples thereof include Toray Silicone DC3PA, Toray Silicone SH7PA, Toray Silicone DC11PA, Toray Silicone SH21PA, Toray Silicone SH28PA, Toray Silicone 29SHPA, Toray Silicone SH30PA, and polyether modified silicone oil SH8400 (manufactured by Toray Silicone Co., Ltd.); KP321, KP322, KP323, KP324, KP326, KP340, KP341 (manufactured by Shin-Etsu Silicone Co., Ltd.); and TSF400, TSF401, TSF410, TSF4300, TSF4440, TSF4445, TSF-4446, TSF4452, and TSF4460 (manufactured by GE Toshiba Silicones Co., Ltd.). The fluorine-based surfactant includes, for example, a surfactant having a fluorocarbon chain. Specific examples thereof include Fluorad FC430 and Fluorad FC431 (manufactured by Sumitomo 3M, Ltd.); Megafac F142D, Megafac F171, Megafac F172, Megafac F173, Megafac F177, Megafac F183, and Megafac R30 (manufactured by Dainippon Ink and Chemicals, Inc.); Eftop EF301, Eftop EF303, Eftop EF351, and Eftop EF352 (manufactured by Shin-Akita Kasei K.K.); Surflon S381, Surflon S382, Surflon SC101, and Surflon SC105 (manufactured by Asahi Glass Co., Ltd.); E5844 (manufactured by Daikin Finechemical Laboratory), and BM-1000 and BM-1100 (manufactured by BM Chemie). The silicone-based surfactant having a fluorine atom includes, for example, a surfactant having a siloxane bond and a fluorocarbon chain. Specific examples thereof include Megafac R08, Megafac BL20, Megafac F475, Megafac F477, and Megafac F443 (manufactured by Dainippon Ink and Chemicals, Inc.). These surfactants may be used alone or in combination.

When the surfactant is used, the content thereof is preferably from 0.0005 to 0.6% by weight, more preferably from 0.001 to 0.5% by weight, based on the colored photosensitive resin composition, since within the above range, the smoothness of the film can be further improved in the case of coating the colored photosensitive resin composition.

When the colored photosensitive resin composition of the present invention is a negative composition, it may further contain an amine compound. The use of the amine compound can prevent a large change in the amount of exposing light upon photolithography before and after storage of the colored photosensitive resin composition for a long period. The use of the amine compound can decrease the dimensional change of a resist pattern caused by deactivation of a photo acid generator when a substrate is allowed to stand after exposure.

Examples of the former amine compound, which is useful to exert the stabilization effect on the amount of exposing light, include amino alcohols such as 3-amino-1-propanol, 1-amino-2-propanol, 2-amino-1-propanol, 2-amino-2-methyl-1-propanol, 2-amino-2-methyl-1-propanol, 2-amino-2-methyl-1,3-propanediol and 3-methyl-2-amino-1-butanol; and compounds having a diazabicyclo structure, such as 1,4-diazabicyclo[2,2,2]octane, 1,8-diazabicyclo[5,4,0]-7-undecene and 1,5-diazabicyclo[4,3,0]non-5-ene.

Examples of the latter amine compound, which is useful to exert the dimension stabilizing effect, include 4-nitroaniline, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, 4,4′-diamino-3,3′,5,5′-tetraethyl-diphenylmethane, 8-quinolinol, benzimidazole, 2-hydroxybenzimidazole, 2-hydroxyquinazoline, 4-methoxybenzylindene-4′-n-butylaniline, salicylic acid amide, salicylanilide, 1,8-bis(N,N-dimethylamino)naphthalene, 1,2-diazine(pyridazine), piperidine, p-amino-benzoic acid, N-acetylethylenediamine, 2-methyl-6-nitroaniline, 5-amino-2-methylphenol, 4-n-butoxyaniline, 3-ethoxy-n-propylamine, 4-methylcyclohexylamine, 4-tert-butylcyclohexylamine, monopyridines (e.g., imidazole, pyridine, 4-methylpyridine, 4-methylimidazole, 2-dimethylaminopyridine, 2-methylaminopyridine, 1,6-dimethylpyridine, etc.), bipyridines (e.g., bipyridine, 2,2′-dipyridylamine, di-2-pyridyl ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(4-pyridyloxy)ethane, 4,4′-dipyridyl sulfide, 4,4′-dipyridyldisulfide, 1,2-bis(4-pyridyl)ethylene, 2,2′-dipicolylamine, 3,3′-dipicolylamine, etc.), and ammonium salts (e.g., tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-(trifluoromethyl)phenyltrimethylammonium hydroxide, choline, etc.).

The content of the amine compound is usually from about 0.01 to 10% by weight, preferably from about 0.1 to 0.8% by weight, based on the solid content of the colored photosensitive resin composition.

Furthermore, the colored photosensitive resin composition of the present invention may optionally contain various components (e.g., epoxy-based resins, oxetane compounds, ultraviolet absorbers, antioxidants, chelating agents, etc.) as long as the effects of the present invention are not adversely affected.

The colored photosensitive resin composition of the present invention can be prepared by mixing the respective components described above in a solvent. When the colored photosensitive resin composition thus prepared is filtered through a filter having a pore diameter of about 0.2 μm or less, impurity substances having a particle size, which is larger than that of the pore size of the filter, can be removed and the colored photosensitive resin composition can be uniformly coated on a substrate in the case of coating.

Using the colored photosensitive resin composition of the present invention, a color filter array can be formed by a photolithography method which is used to form a color filter array from a conventional colored photosensitive resin composition. In the photolithography method, for example, a coating film made of the colored photosensitive resin composition of the present invention is formed on a substrate and the coating film is exposed, developed and optionally cured by heating to form a pixel. When the formation, exposure and development of the coating film are repeated for each color, a color filter array is formed.

The substrate may be a conventional one, and examples of the substrate include a silicon wafer, a transparent glass plate or a quartz plate, on which an image sensor such as a solid CCD is formed.

To form the coating film on the substrate, for example, the colored photosensitive resin composition of the present invention is coated on the substrate using a coating method such as a spin coating method, a roll coating method, a bar coating method, a die coating method, a dipping method, a casting coating method, a roll coating method, a slit & spin coating method, etc., and then volatile components such as a solvents is removed by heating preferably at a temperature of 70 to 120° C. to form the coating film of the colored photosensitive resin composition of the present invention.

Then, the coating film is exposed. In the exposure process, a mask pattern with a pattern corresponding to the objective pattern is used and the coating film is irradiated with light through the mask pattern. Examples of light ray used in the exposure process include g-ray and i-ray, and the exposure process is conducted using a stepper such as g-ray stepper or i-ray stepper. An exposure dose of light ray in the irradiate area is appropriately selected according to the kind and content of the photosensitive compound, the kind and content of the curing agent, and the polystyrene-converted weight average molecular weight, monomer ratio and content of the alkali-soluble resin. The coating film thus exposed may be heated. The coating film is preferably heated because the curing agent is cured and therefore the mechanical strength of the coating film increases. The heating temperature is preferably from 80 to 150° C.

After the exposure process, the resulting coating film is developed. Similar to the case of using a conventional colored photosensitive resin composition, the coating film is developed by bringing the substrate carrying the coating film into contact with a developing solution. The kind of the developing solution is not particularly limited. For example, an aqueous alkaline solution is used. The desired pixels can be obtained by shaking off the developing solution from the substrate surface and washing the substrate with water. Alternatively, the developing solution is shaken off, followed by rinsing with a rinsing solution and further washing with water. By rinsing, the residue derived from colored photosensitive resin composition remained on the substrate upon development can be removed.

Then, the pixels of the coating film after developing may be irradiated with ultraviolet ray. Thereby, the residual photosensitive compound can be decomposed. Furthermore, the mechanical strength of the pixels can be increased by heating after washing with water. The heating temperature is preferably from 160 to 220° C., since within the above temperature range, the curing agent sufficiently promotes curing, while the dye is not decomposed.

The thickness of the color filter array produced as above is preferably from about 0.4 to 2.0 μm. The longitudinal length and the lateral length of each pixel can be independently set within a range from about 1.0 to 20 μm.

The color filter array of the present invention can be formed on a device such as a solid image pickup device (e.g., CCD, etc.) and a liquid crystal display, and is useful for coloration of such a device.

Typical examples in the case of forming the color filter array of the present invention on a CCD image sensor, and a camera system using the same will now be described in more detail with reference to the accompanying drawings.

CCD Image Sensor:

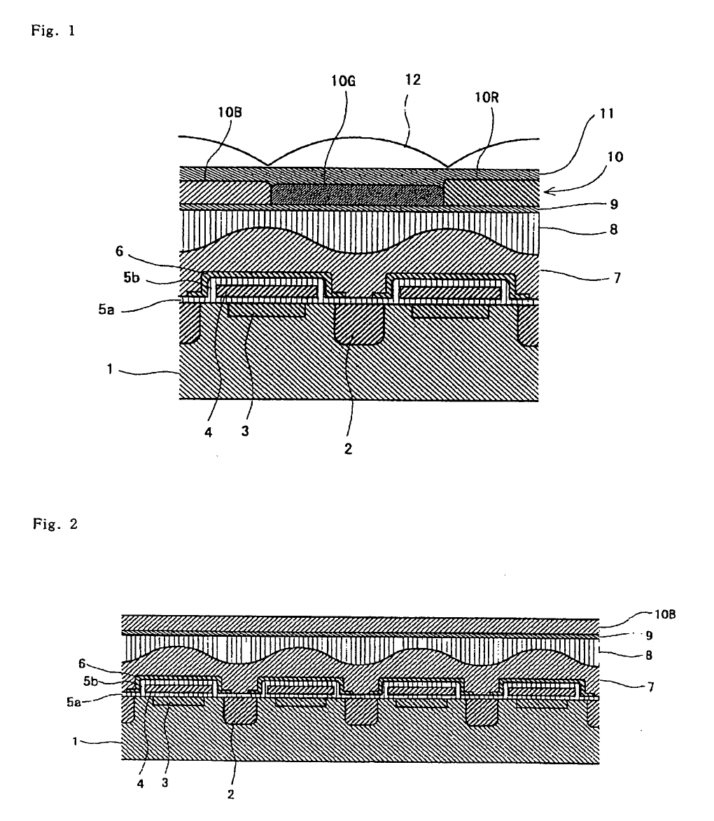

FIG. 1 is a partially enlarged schematic sectional view showing one example of a CCD image sensor on which the color filter array of the present invention is formed, and FIGS. 2 to 7 are partially enlarged schematic sectional views showing procedures for the formation of a color filter on the CCD image sensor shown in FIG. 1.

In the case of a CCD image sensor depicted in the drawings, a photodiode 2 is formed by ion-injecting N-type impurities such as P and As into a portion of the surface of a P-type impurity region in a silicon substrate 1, followed by a heat treatment. Also, a vertical charge transfer section 3 composed of an impurity diffusion layer having an N-type impurity concentration, which is higher than that of the photodiode 2, is formed on the region which exists on the same surface but is different from the portion where the photodiode 2 is formed. The vertical charge transfer section 3 is formed by ion-injecting N-type impurities such as P and As, followed by a heat treatment, and play a role of a vertical Burried Channel layer (CCD) capable of transferring charges generated when the photodiode 2 receives incident light.

In this example, the impurity region of the silicon substrate 1 serves as a P-type impurity layer, while the photodiode 2 and the vertical charge transfer section 3 serve as an N-type impurity layer. Alternatively, the impurity region of the silicon substrate 1 can serve as an N-type impurity layer, while the photodiode 2 and the vertical charge transfer section 3 can serve as a P-type impurity layer.

An insulation film 5a made of, for example, SiO₂ is formed on the silicon substrate 1, the photodiode 2 and the vertical charge transfer section 3, and a vertical charge transfer electrode 4 made of, for example, polysilicon is formed over the vertical charge transfer section 3 through the insulation film 5a. The vertical charge transfer electrode 4 plays a role of a transfer gate capable of transferring charges generated in the photodiode 2 to the vertical charge transfer section 3, and a role of a transfer electrode capable of transferring charges transferred to the vertical charge transfer section 3 to the vertical direction of a chip.

Above and at the side of the vertical charge transfer electrode 4, a light shielding layer 6 is formed through an insulation film 5b made of, for example, SiO₂. The light shielding film 6 is made of tungsten, tungsten silicide, or metal such as Al or Al-silicide, and play a role of preventing incident light from entering into the vertical charge transfer electrode 4 and the vertical charge transfer section 3. Above the photodiode 2 out of the side of the light shielding film 6, a light shielding film 6 is provided with a projecting section, thereby making it possible to prevent incident light from leaking into the vertical charge transfer section 3.

Above the light shielding film 6, for example, a BPSG film 7 is formed with in the form of downward convex against the photodiode 2, and then on the BPSG film 7, a P—SiN film 8 is laminated. Thus, the BPSG film 7 and the P—SiN film 8 are formed such that an interface between them is formed in the form of curving downward above the photodiode 2, and plays a role of an interlayer lens for efficiently bringing incident light to the photodiode 2. For the purpose of flattening irregular portions other than the surface of the P—SiN film 8 or the pixel area, a flattened film layer 9 is formed.

On a flattened film layer 9, a color filter array 10 is formed. The color filter array 10 may be formed in accordance with the above photolithography method. Description is made by way of the CCD image sensor as an example as shown in FIGS. 2 to 7. While the description is made by way of a negative colored photosensitive resin composition in this illustrated example, a positive colored photosensitive resin composition may also be used.

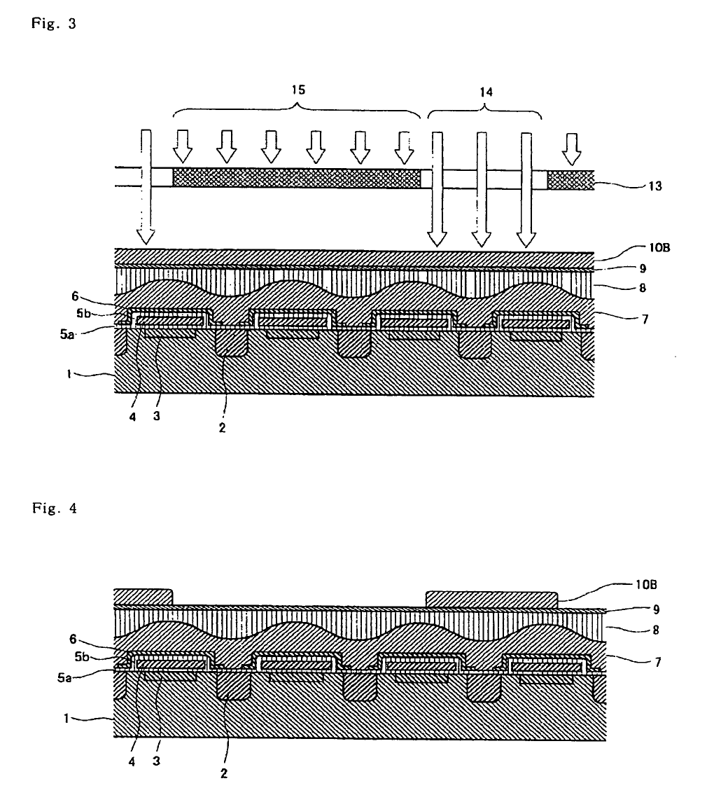

To form the color filter array, firstly, a photosensitive resin composition colored with the first color (in the illustrated example, a blue photosensitive resin composition 10B) is applied on a flattened film 9 (FIG. 2) and then projection exposure of a pattern through a photomask 13 is conducted (FIG. 3). This exposure makes the photosensitive resin composition in the exposed area 14 insoluble in a developing solution. The photosensitive resin composition in the unexposed area 15 is soluble in the developing solution and then dissolved in the developing solution to form a pattern. Thereafter, the insolubilized photosensitive resin composition in the remaining exposed area is thermocured to form a desired blue pixel pattern 10B (FIG. 4).

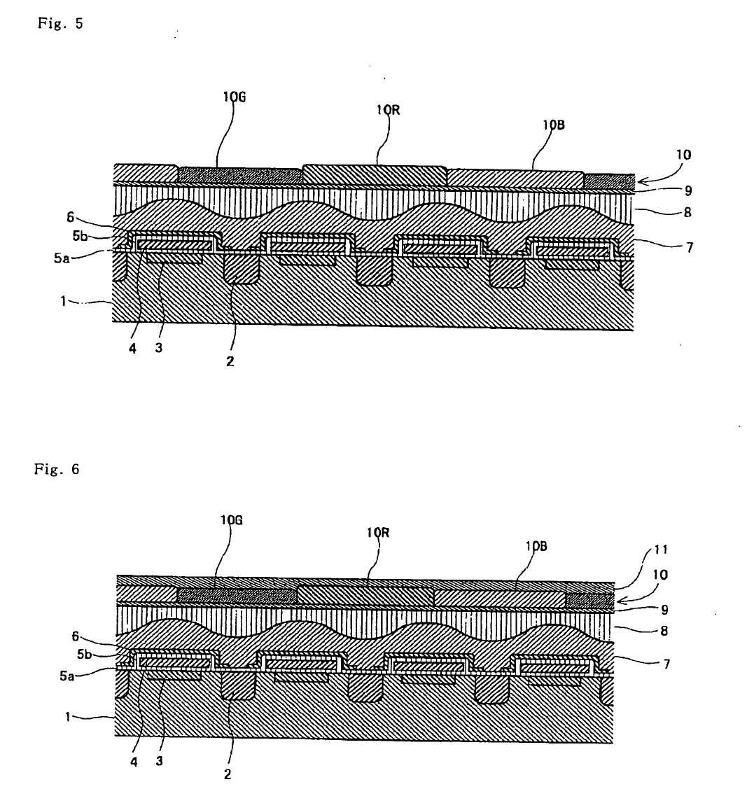

Next, the same step is repeated with respect to pixel patterns of other colors (in the illustrated example, a red pixel pattern 10R and a green pixel pattern 10G) to form pixel patterns of three colors on the same plane of the substrate on which the image sensor is formed (FIG. 5).

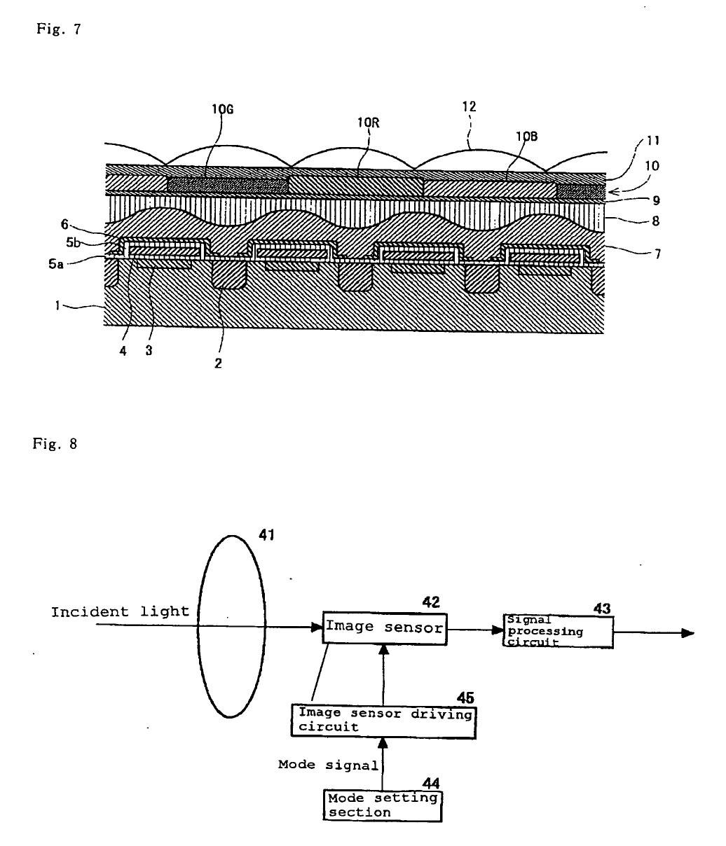

On the surface of the color filter array 10 thus formed, a flattened film 11 is formed (FIG. 6) for the purpose of flattening the irregularity. Furthermore, a microlens 12 for efficiently collecting light incident to a photodiode 2 is formed on the top surface of the flattened film 11 (FIG. 7), thereby forming a CCD image sensor and a camera system using the same.

Camera System:

FIG. 8 is a block diagram showing an example of a camera system into which a solid image pickup device (image sensor) is assembled. In this camera system, incident light is illuminated on an image sensor 42 via a lens 41. On the light incident side of the image sensor 42, the above on-chip lens (microlens) 12 and color filter array 10 are formed, and a signal corresponding to each color of incident light is outputted. The signal from the image sensor 42 is signal-processed by the signal processing circuit 43 and then outputted to the camera.

In the camera system of the illustrate example, the image sensor 42 is driven by a device driving circuit 45. The operation of the device driving circuit 45 can be controlled by sending a mode signal such as a static image mode or a moving image mode from a mode setting section 44.

The present invention can be applied to not only a CCD image sensor, but also an amplified solid image pickup device such as a CMOS image sensor, and a camera system and a liquid crystal display using the same.

### EXAMPLES

The present invention is further illustrated by the following examples. It is to be understood that the present invention is not limited to the examples, and various design variations made in accordance with the purports described hereinbefore and hereinafter are also included in the scope of the present invention.

### Synthesis Example 1

36.0 parts by weight of poly(p-hydroxystyrene) [trade name: “MARUKA LYNCUR M” (manufactured by Maruzen Petrochemical Co., Ltd.), weight average molecular weight (catalog value): 4,100, dispersion degree (catalog value): 1.98] and 144 parts by weight of acetone were charged in a reaction vessel and then dissolved while stirring. To the solution, 20.7 parts by weight of anhydrous potassium carbonate and 9.35 parts by weight of ethyl iodide were added, and then reflux was initiated by heating. After reflux was continued for 15 hours, 72 parts by weight of methyl isobutyl ketone was added, and the organic layer was washed with 92.8 parts by weight of a 2 wt.% aqueous oxalic acid solution. Then, 96 parts by weight of ethyl isobutyl ketone was added and the organic layer was washed with 64.7 parts by weight of ion-exchange water. The organic layer after washing was concentrated to 78.3 parts by weight and, after 187.9 parts by weight of propylene glycol monomethyl ether acetate was added, the organic layer was further concentrated to 117.4 parts by weight. The resulting concentrated solution had a solid content of 30.6% by weight. ¹H-NMR measurement revealed that 19.5% of the hydroxyl groups of poly(p-hydroxystyrene) were ethyletherified in the resin after the reaction. This resin is referred to as Resin A.

### Example 1

Twenty (20) parts by mass of a colorant represented by the formula (I-1a) as a primary colorant, 4 parts by mass of α-[(4-toluenesulfonyloxyimino)-4-methoxyphenyl]acetonitrile as a photosensitive compound (a photo acid generator), 59.45 parts by mass (in terms of a solid content) of Resin A as an alkali-soluble resin, 0.15 part by mass of 2-amino-2-methyl-1-propanol as an amine compound, 16.4 parts by mass of hexamethoxymethylolmelamine as a curing agent, 480 parts by mass of 4-hydroxy-4-methyl-2-pentanone as a solvent, and 120 parts by mass of propylene glycol monomethyl ether as a solvent were mixed and then filtered through a membrane filter having a pore diameter of 0.2 μm to obtain a blue colored photosensitive resin composition.

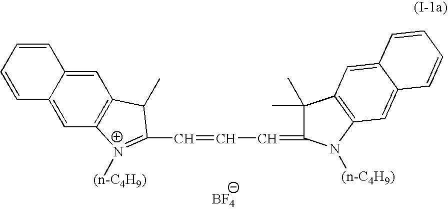

On a quartz wafer, the colored photosensitive resin composition was applied using a spin coating method so as to control the thickness of a resulting film to 0.70 μm, and then heated at 100° C. for one minute thereby to remove volatile components, and thus a coating film was formed. The coating film was irradiated with ultraviolet ray and then heated at 200° C. for 3 minutes to obtain a blue filter.

### Example 2

A blue filter was produced in same manner as in Example 1, except that 20 parts by mass of the colorant (I-1a) was used as the primary colorant, 10 parts by mass of the colorant represented by the formula (IIIa) was used as the secondary colorant, and 49.25 parts by mass (in terms of a solid content) of Resin A was used as the alkali-soluble resin.

### Example 3

A blue filter was produced in same manner as in Example 1, except that 20 parts by mass of the colorant (II-a) was used as the primary colorant, 10 parts by mass of a colorant represented by the formula (I-6a) was used as the secondary colorant, and 49.25 parts by mass (in terms of a solid content) of Resin A was used as the alkali-soluble resin.

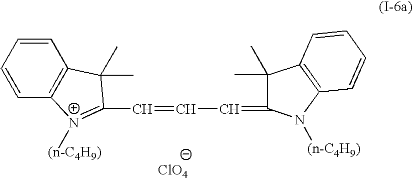

### Example 4

A blue filter was produced in same manner as in Example 1, except that 20 parts by mass of the colorant (I-1a) was used as the primary colorant, 10 parts by mass of a colorant represented by the formula (I-6a) was used as the secondary colorant, and 49.25 parts by mass (in terms of a solid content) of Resin A was used as the alkali-soluble resin.

### Comparative Example 1

A blue filter was produced in same manner as in Example 1, except that the colorant (IIa) was used as the primary colorant in place of the colorant (I-1a).

### Comparative Example 2

A blue filter was produced in same manner as in Example 1, except that 20 parts by mass of the colorant (IIa) was used as the primary colorant, 10 parts by mass of a colorant represented by the formula (IIIa) was used as the secondary colorant, and 49.25 parts by mass (in terms of a solid content) of Resin A was used as the alkali-soluble resin.

Spectral Evaluation:

Light transmittance at a wavelength of 450 nm and 550 nm of the blue filters obtained in Examples 1 to 4 and Comparative Examples 1 and 2 were measured. The results are shown in Table 1 below.

TABLE 1

| | | |
|---|---|---|
| | | Light transmit- |
| | | tance at a |
| Primary | Secondary | wavelength of: |

| | colorant | colorant | 440 nm | 550 nm |
|---|---|---|---|---|
| Example 1 | I-1a | — | 96% | 41% |
| Example 2 | I-1a | IIIa | 95% | 36% |
| Example 3 | IIa | I-6a | 93% | 47% |
| Example 4 | I-1a | I-6a | 95% | 27% |
| Comparative | IIa | — | 95% | 73% |
| Example 1 | | | | |
| Comparative | IIa | IIIa | 93% | 62% |
| Example 2 | | | | |

As can be seen from the results shown in Table 1, the blue filter of Example 1 using the colorant (I-1a) as the primary colorant showed high light transmittance at a wavelength of 440 nm and low light transmittance at a wavelength of 550 nm in comparison with the blue filter of Comparative Example 1 using the colorant (IIa), and the blue filter of Example 1 was therefore excellent in color reproducibility as a light receiving device. Also, when the colorant (I-1a) was used in combination with the colorant (IIIa) for color matching, the blue filter of Example 2 using the colorant (I-1a) showed high light transmittance at a wavelength of 440 nm and low light transmittance at a wavelength of 550 nm in comparison with the blue filter of Comparative Example 2 using the colorants (IIa) and (IIIa).

The blue filter of Example 3 using the colorant (IIa) as the primary colorant and the colorant (I-6a) as the secondary colorant showed low light transmittance at a wavelength of 550 nm and it was excellent in color reproducibility in comparison with the blue filter of Comparative Example 2 using the colorant (IIIa) as the secondary colorant. The blue filter of Example 4 using the colorant (I-1a) as the primary colorant and the colorant (I-6a) as the secondary colorant achieved a remarkably decreased light transmittance of 27% at 550 nm while maintaining a high light transmittance of 95% at a wavelength of 440 nm, in comparison with other blue filters of Example 1 to 3, and it was most excellent in color reproducibility.

The colored photosensitive resin composition of the present invention can be used to produce a color filter array to be formed on devices for coloration of solid image pickup devices (e.g., image sensor, etc.) and liquid crystal display devices.

1. A colored photosensitive resin composition comprising an alkali-soluble resin, a photosensitive compound, a curing agent, a solvent and a cyanine colorant represented by the formula (I): 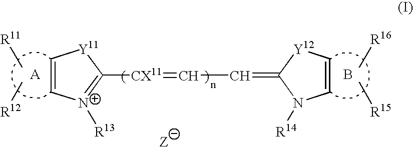
wherein
Z⁻ represents Cl⁻, Br⁻, I⁻, ClO₄⁻, OH⁻, a carboxylate anion, a sulfonate anion, or a borate anion;
Y¹¹ and Y¹² each independently represents a sulfur atom, an oxygen atom, a selenium atom, an ethylene group, or a dimethylmethylene group;
X¹¹ represents a hydrogen atom or a halogen atom;
R¹¹, R¹², R¹⁵ and R¹⁶ each independently represents a hydrogen atom, a chlorine atom, a C₁₋₄ alkyl group, a C₁₋₄ haloalkyl group, an ethylenyl group, a styryl group, a C₁₋₄ alkoxyl group, a phenyl group, a naphthyl group, a phenyl group substituted with a C₁₋₄ alkyl group, a hydroxyphenyl group, a halophenyl group, a nitrophenyl group, an aminophenyl group, a nitro group, an amino group, or a hydroxyl group;
R¹³ and R¹⁴ each independently represents a C₁₋₈ alkyl group, a C₁₋₈ alkoxyl group, or a C₁₋₈ hydroxyalkyl group;
n represents an integer from 1 to 5; and
rings A and B represented by a dotted line each independently represents a benzene ring or a naphthalene ring.

2. The colored photosensitive resin composition according to claim 1, wherein the photosensitive compound is an oxime compound.

3. A color filter array formed from the colored photosensitive resin composition according to claim 1.

4. A solid image pickup device comprising the color filter array according to claim 3.

5. A camera system comprising the color filter array according to claim 4.

6. A color filter array formed from the colored photosensitive resin composition according to claim 2.
